(19) United States
(12) Patent Application Publication
(10) Pub. No.: US 2008/0067956 A1
(43) Pub. Date: Mar. 20, 2008

(54) Lamp Power Circuit Sensing Method And System

(75) Inventors: Ching-Yao Hung, Palatine, IL (US); Robert A. Erhardt, Schaumburg, IL (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,606

(22) PCT Filed: Nov. 4, 2005
(86) PCT No.: PCT/IB05/53611

§ 371 Date: May 4, 2007

Related U.S. Application Data
(60) Provisional application No. 60/625,670, filed on Nov. 5, 2004.

(51) Int. Cl. H05B 31/02

(52) U.S. Cl. 315/307

(57) ABSTRACT

A lamp power circuit sensing system includes a unidirectional stage (22) having a unidirectional current, a bidirectional stage (24) operably connected to the unidirectional stage (22), and a power sensor (32, 34) operably connected to monitor the unidirectional current and to generate an indicated lamp signal (33, 35). The lamp power circuit sensing system further includes a power regulation circuit (19) having a lamp output (17) providing bidirectional lamp voltage (42), and a lamp voltage sensing circuit (26) operably connected across the lamp output (17) to generate indicated lamp voltage (46) in response to the bidirectional lamp voltage (42).

This invention relates generally to lamp power circuits, and more specifically to methods and systems for sensing conditions in lamp power circuits.

Lamp power circuits rely to an increasing degree on electronic components to provide well-regulated power to ignite and control the lamp. To maintain good power regulation, it is necessary to monitor power supplied to the lamp for current, voltage, and power. The lamp power circuit can be adjusted in response to this data to obtain the desired operating point for desired operation, such as maintaining tight power regulation for good lumen maintenance.

Present lamp power circuits rely on current, voltage, and power sensing which, unfortunately, do not always indicate the state of the actual power being supplied to the lamp. Common practice in power sensing is to sense lamp power at the input side of the output stage of the lamp power circuit. This simple design approach is limited to lamp power circuits in which the current flows in a single direction, i.e., is unidirectional. When the current flows in two directions, i.e., is bidirectional, excessive noise prevents an accurate power measurement and precludes use of the sensed power to regulate lamp power. Common practice in voltage sensing is to sense bus voltage and consider the sensed bus voltage as indicative of the lamp voltage. For certain lamp power circuits, however, bus voltage fails to provide a measure of lamp voltage. In addition, lamp voltage is typically an AC signal, which is noisy and difficult to measure directly.

It would be desirable to have a lamp power circuit sensing method and system that overcomes the above disadvantages.

One aspect of the present invention provides a lamp power circuit sensing system including a unidirectional stage having a unidirectional current, a bidirectional stage operably connected to the unidirectional stage, and a power sensor operably connected to monitor the unidirectional current and to generate an indicated lamp signal.

Another aspect of the present invention provides a lamp power circuit sensing system including a power regulation circuit having a lamp output providing bidirectional lamp voltage, and a lamp voltage sensing circuit operably connected across the lamp output to generate indicated lamp voltage in response to the bidirectional lamp voltage.

Another aspect of the present invention provides a lamp power circuit sensing method including providing bidirectional current to a lamp output from a bidirectional stage; providing a unidirectional stage operably connected to the bidirectional stage, the unidirectional stage having a unidirectional current; monitoring the unidirectional current; and generating an indicated lamp signal in response to the unidirectional current.

Another aspect of the present invention provides lamp power circuit sensing method including monitoring bidirectional lamp voltage at a lamp output, and rectifying and differentially amplifying the bidirectional lamp voltage to generate indicated lamp voltage.

Another aspect of the present invention provides a lamp power circuit sensing system including a bidirectional stage providing bidirectional current to a lamp output; a unidirectional stage operably connected to the bidirectional stage, the unidirectional stage having a unidirectional current; means for monitoring the unidirectional current; and means for generating an indicated lamp signal in response to the unidirectional current.

Another aspect of the present invention provides a lamp power circuit sensing system including means for monitoring bidirectional lamp voltage at a lamp output, and means for rectifying and differentially amplifying the bidirectional lamp voltage to generate indicated lamp voltage.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

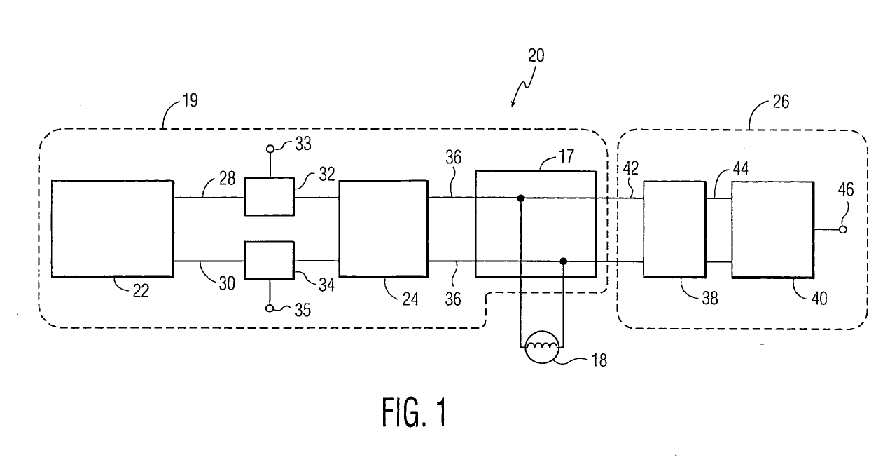

FIG. 1 is a block diagram of a lamp power circuit sensing system made in accordance with the present invention;

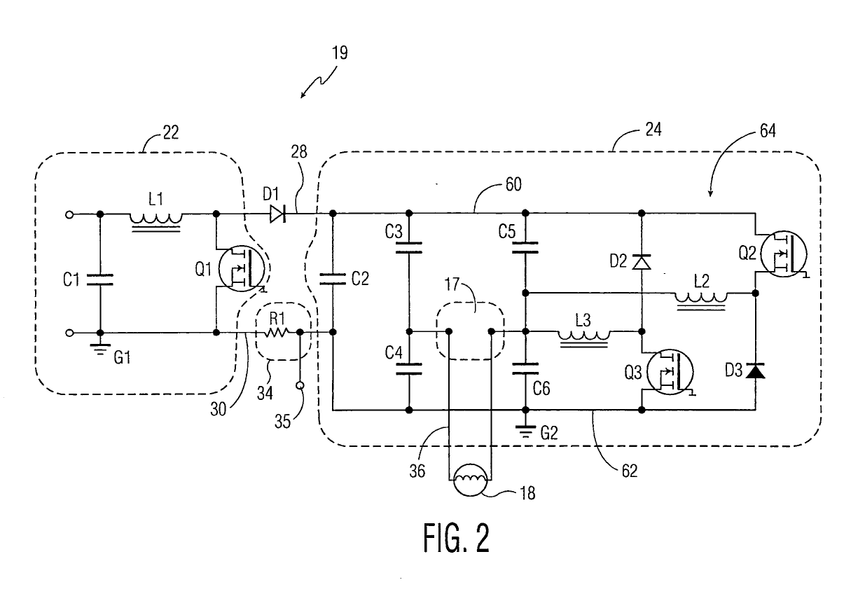

FIG. 2 is a schematic diagram of a power sensing circuit of a lamp power circuit sensing system made in accordance with the present invention; and

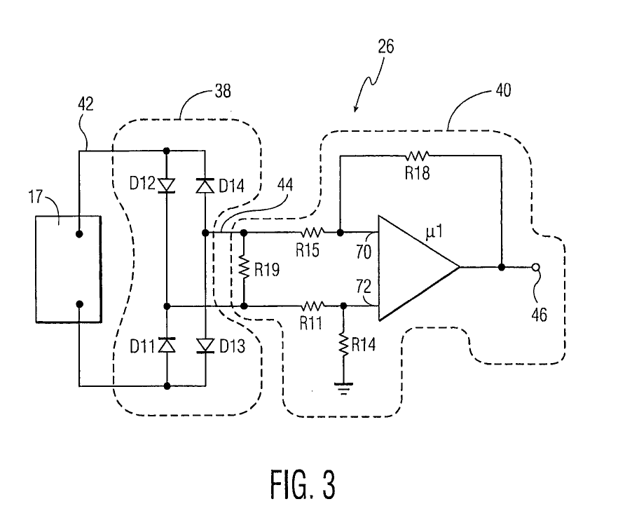

FIG. 3 is a schematic diagram of a lamp voltage sensing circuit of a lamp power circuit sensing system made in accordance with the present invention.

FIG. 1 is a block diagram of a lamp power circuit sensing system made in accordance with the present invention. Lamp power circuit 20 for providing power to a lamp 18 includes a power regulation circuit 19 and a lamp voltage sensing circuit 26.

The power regulation circuit 19 includes a unidirectional stage 22, a bidirectional stage 24, and a lamp output 17. The unidirectional stage 22 is operably connected to the bidirectional stage 24, providing supply current 28 to the bidirectional stage 24 and receiving return current 30 from the bidirectional stage 24. The supply current 28 and the return current 30 are unidirectional currents, i.e., unidirectional direct current (DC). The bidirectional stage 24 is operably connected to the lamp output 17 to provide bidirectional current 36 to the lamp 18. The bidirectional current 36 is alternating current (AC). The bidirectional stage 24 can be a boost converter, a buck converter, an AC/DC converter, or the like.

A power sensor between the unidirectional stage 22 and the bidirectional stage 24 monitors unidirectional current to generate an indicated lamp signal. In one embodiment, a supply power sensor 32 monitors the supply current 28 to generate the indicated lamp signal 33. In an alternative embodiment, a return power sensor 34 monitors the return current 30 to generate the indicated lamp signal 35. The indicated lamp signal can be indicated lamp current or indicated lamp power. In one embodiment, the power sensor measures voltage at a resistor to determine current thorough the resistor as an indication of lamp current. In one embodiment, the power sensor measures voltage at a resistor and squares the voltage to determine lamp power.

Those skilled in the art will appreciate that the power regulation circuit 19 can include intermediate and additional stages as desired for a particular application. For example, the unidirectional stage 22 can be supplied power by an additional AC or DC power supply, or AC/DC converter. A power sensor can be located at any stage and anywhere in the power regulation circuit 19 that unidirectional current is present to monitor the unidirectional current and generate an indicated lamp signal.

The lamp voltage sensing circuit 26 includes a rectifier 38 and a differential amplifier circuit 40. The lamp voltage sensing circuit 26 is operably connected to the lamp output 17 across the lamp 18. The rectifier 38 rectifies bidirectional lamp voltage 42 across the lamp output 17 to generate rectified lamp voltage 44. The rectifier 38 can be a full bridge rectifier, a half bridge rectifier, or the like. The differential amplifier circuit 40 operably connected to the rectifier 38 differentially amplifies the rectified lamp voltage 44 to generate an indicated lamp voltage 46.

FIG. 2, in which like elements share like reference numbers with FIG. 1, is a schematic diagram of a power sensing circuit of a lamp power circuit sensing system made in accordance with the present invention. The power regulation circuit 19 includes a return power sensor 34 indicating power to the lamp 18, the return power sensor 34 being located between the unidirectional stage 22 and the bidirectional stage 24 and monitoring the return current 30. In one embodiment, the unidirectional stage 22 is connected immediately before the bidirectional stage 24. In an alternative embodiment, at least one intermediate stage is connected between the unidirectional stage 22 and the bidirectional stage 24.

The unidirectional stage 22 is a boost converter stage in the example of FIG. 2. The unidirectional stage 22 includes capacitor C1, inductor L1, and switch Q1. An input DC voltage is applied across the capacitor C1 connected to ground G1, and switch Q1 switched to boost the input DC voltage to a desired output DC voltage at diode D1, through which supply current 28 flows. Those skilled in the art will appreciate that a number of topologies can be used to establish the desired output DC voltage at diode D1. For example, the unidirectional stage 22 can be a boost converter or a buck converter. In addition, one or more additional stages, such as AC/DC or DC/DC converters, can be used to establish the input DC voltage across the capacitor C1.

The bidirectional stage 24 converts the output DC voltage to an alternating bidirectional current 36 to drive the lamp 18, which is connected across the lamp output 17. The capacitor C2 is connected between DC bus 60 and common 62 at ground G2 to receive the output DC voltage. One terminal of the lamp output 17 is connected between capacitor C3 and capacitor C4, which are connected in series between the DC bus 60 and the common 62. Another terminal of the lamp output 17 is connected between capacitor C5 and capacitor C6, which are connected in series between the DC bus 60 and the common 62. A switching circuit 64 includes diode D2 and switch Q3 connected between the DC bus 60 and the common 62, with one end of inductor L3 connected between the diode D2 and the switch Q3 and another end of the inductor L3 connected between the capacitor C5 and the capacitor C6. The switching circuit 64 further includes switch Q2 and diode D3 connected between the DC bus 60 and the common 62, with one end of inductor L2 connected between the switch Q2 and the diode D3 and another end of the inductor L2 connected between the capacitor C5 and the capacitor C6. By alternately switching the switch Q2 and the switch Q3, the switching circuit 64 generates the bidirectional current 36 at the lamp output 17. In the example shown, the switches Q1, Q2, and Q3 are MOSFETs, although other types of switches can be used. Those skilled in the art will appreciate that various switching circuits and configurations of the bidirectional stage 24 can be used to convert the supply current 28 to the bidirectional current 36.

The return power sensor 34 includes a resistor R1 connected between the bidirectional stage 24 and the unidirectional stage 22. The return current 30 flows through the return power sensor 34. In one embodiment, the return power sensor 34 generates the indicated lamp signal 35 by monitoring a single voltage on the end of the resistor R1 nearer the bidirectional stage 24. Measurement of the single voltage on one end of the resistor R1 can be employed when the voltage from the unidirectional stage 22 is well regulated so that the voltage on the end of the resistor R1 nearer the unidirectional stage 22 is nearly constant. In an alternative embodiment, the return power sensor 34 generates the indicated lamp signal 35 as the indicated lamp signal by monitoring the voltage difference across the resistor R1. Measurement of the voltage difference across the resistor R1 can be employed when the voltage from the unidirectional stage 22 varies, so that the voltage on the end of the resistor R1 nearer the unidirectional stage 22 varies.

The single voltage and/or the voltage difference can be used to calculate the current and/or power through the resistor R1, which indicates the current and/or power provided to the lamp 18. The voltage or the voltage difference is proportional to the current through the resistor R1 and the current provided to the lamp 18. The square of the voltage or the voltage difference is proportional to the power through the resistor R1 and the power provided to the lamp 18. The indicated current and/or power, such as indicated lamp signal 35, can be used to control the current and/or power to the lamp 18.

Those skilled in the art will appreciate that in one alternative a resistor can be installed in series with the diode D1, so that the resistor is a supply power sensor monitoring the supply current 28. The supply power sensor can be used instead of or in addition to the return power sensor 34. A power sensor can be installed anywhere in the power regulation circuit 19 where unidirectional current is present. For example, a power sensor can be installed at an intermediate stage connected between the unidirectional stage 22 and the bidirectional stage 24, or before the unidirectional stage 22, where unidirectional current is present.

FIG. 3, in which like elements share like reference numbers with FIG. 1, is a schematic diagram of a lamp voltage sensing circuit of a lamp power circuit sensing system made in accordance with the present invention. The lamp voltage sensing circuit 26 includes rectifier 38 and a differential amplifier circuit 40, providing an indicated lamp voltage 46.

The rectifier 38 is operably connected to the lamp output 17 across the lamp 18 to monitor bidirectional lamp voltage 42. The rectifier 38 includes diodes Dll, D12, D13, and D14 connected across the lamp output 17 as a full bridge rectifier. The connection between diodes D11 and D12, and the connection between diodes D13 and D14 are connected across resistor R19 to provide rectified lamp voltage 44 to the differential amplifier circuit 40. Those skilled in the art will appreciate that the rectifier 38 can be any rectifier for generating a DC voltage from the bidirectional lamp voltage 42, such as a full bridge rectifier, a half bridge rectifier, or the like.

The differential amplifier circuit 40 receives the rectified lamp voltage 44 from the rectifier 38 and generates the indicated lamp voltage 46. The rectified lamp voltage 44 is applied across resistor R19, one end of which is connected to first input 70 of differential amplifier U1 through the resistor R15 and another end of which is connected to the second input 72 of the differential amplifier U1 through the resistor R11. The first input 70 is also connected to the indicated lamp voltage 46 at the output of the differential amplifier U1 through resistor R18, feeding back the indicated lamp voltage 46. The second input 72 is also connected to common through resistor R14. The differential amplifier circuit 40 amplifies and conditions the rectified lamp voltage 44 to generate the indicated lamp voltage 46.

Those skilled in the art will appreciate that the rectifying and differentially amplifying the bidirectional lamp voltage can be performed in different orders. In one alternative embodiment, the differential amplifier circuit 40 precedes the rectifier 38 in the lamp voltage sensing circuit 26. The differential amplifier circuit 40 is connected to the lamp output 17 across the lamp 18 to monitor bidirectional lamp voltage 42. The differential amplifier circuit 40 generates a differential lamp voltage in response to the bidirectional lamp voltage 42. The rectifier 38 is responsive to the differential lamp voltage to generate the indicated lamp voltage 46.

While the embodiments of the invention disclosed herein are presently considered to be preferred, various changes and modifications can be made without departing from the scope of the invention. Those skilled in the art will appreciate that the embodiments described for FIGS. 1-3 are exemplary and that alternative circuits can be used as desired for particular applications. The scope of the invention is indicated in the appended claims, and all changes that come within the meaning and range of equivalents are intended to be embraced therein.

1. A lamp power circuit sensing system comprising:
a unidirectional stage 22, the unidirectional stage 22 having a unidirectional current;
a bidirectional stage 24, the bidirectional stage 24 being operably connected to the unidirectional stage 22; and
a power sensor 32, 34, the power sensor 32, 34 being operably connected to monitor the unidirectional current and to generate an indicated lamp signal 33, 35.

2. The system of claim 1 wherein the unidirectional current is selected from the group consisting of a supply current 28 and a return current 30.

3. The system of claim 1 wherein the unidirectional stage 22 is connected immediately before the bidirectional stage 24.

4. The system of claim 1 wherein at least one intermediate stage is connected between the unidirectional stage 22 and the bidirectional stage 24.

5. The system of claim 1 wherein the bidirectional stage 24 is selected from the group consisting of a boost converter, a buck converter, and an AC/DC converter.

6. The system of claim 1 wherein the power sensor 32, 34 is a resistor conducting the unidirectional current, and the indicated lamp signal 33, 35 is measured at one end of the resistor.

7. The system of claim 1 wherein the power sensor 32, 34 is a resistor conducting the unidirectional current, and the indicated lamp signal 33, 35 is measured across the resistor.

8. The system of claim 1 wherein the indicated lamp signal 33, 35 is selected from the group consisting of indicated lamp current and indicated lamp power.

9. A lamp power circuit sensing system comprising:
a power regulation circuit 19, the power regulation circuit 19 having a lamp output 17 providing bidirectional lamp voltage 42; and
a lamp voltage sensing circuit 26, the lamp voltage sensing circuit 26 operably connected across the lamp output 17 to generate indicated lamp voltage 46 in response to the bidirectional lamp voltage 42.

10. The system of claim 9 wherein the lamp voltage sensing circuit 26 comprises:
a rectifier 38, the rectifier 38 being operably connected across the lamp output 17 to monitor the bidirectional lamp voltage 42 and to generate rectified lamp voltage 44; and
a differential amplifier circuit 40, the differential amplifier circuit 40 being responsive to the rectified lamp voltage 44 to generate the indicated lamp voltage 46.

11. The system of claim 9 wherein the lamp voltage sensing circuit 26 comprises:
a differential amplifier circuit 40, the differential amplifier circuit 40 being operably connected across the lamp output 17 to monitor the bidirectional lamp voltage 42 and to generate differential lamp voltage; and
a rectifier 38, the rectifier 38 being responsive to the differential lamp voltage to generate the indicated lamp voltage 46.

12. A lamp power circuit sensing method comprising:
providing bidirectional current to a lamp output from a bidirectional stage;
providing a unidirectional stage operably connected to the bidirectional stage, the unidirectional stage having a unidirectional current;
monitoring the unidirectional current; and
generating an indicated lamp signal in response to the unidirectional current.

13. The method of claim 12 wherein the unidirectional current is selected from the group consisting of a supply current and a return current.

14. The method of claim 12 wherein the providing a unidirectional stage comprises providing a unidirectional stage connected immediately before the bidirectional stage.

15. The method of claim 12 wherein the providing a unidirectional stage comprises providing a unidirectional stage with at least one intermediate stage connected between the unidirectional stage and the bidirectional stage.

16. The method of claim 12 wherein the monitoring the unidirectional current comprises monitoring voltage at a resistor conducting the unidirectional current.

17. The method of claim 16 wherein the indicated lamp signal is indicated lamp current.

18. The method of claim 16 wherein the generating an indicated lamp signal comprises squaring the voltage, and the indicated lamp signal is indicated lamp power.

19. The method of claim 12 wherein the monitoring the unidirectional current comprises monitoring voltage across a resistor conducting the unidirectional current.

20. The method of claim 19 wherein the indicated lamp signal is indicated lamp current.

21. The method of claim 19 wherein the generating an indicated lamp signal comprises squaring the voltage, and the indicated lamp signal is indicated lamp power.

22. A lamp power circuit sensing method comprising:
monitoring bidirectional lamp voltage at a lamp output; and
rectifying and differentially amplifying the bidirectional lamp voltage to generate indicated lamp voltage.

23. The method of claim 22 wherein the rectifying and differentially amplifying the bidirectional lamp voltage comprises:
rectifying the bidirectional lamp voltage to generate rectified lamp voltage; and
differentially amplifying the rectified lamp voltage to generate the indicated lamp voltage.

24. The method of claim 22 wherein the rectifying and differentially amplifying the bidirectional lamp voltage comprises:
differentially amplifying the bidirectional lamp voltage to generate differential lamp voltage; and
rectifying the differential lamp voltage to generate the indicated lamp voltage.

25. A lamp power circuit sensing system comprising:
a bidirectional stage providing bidirectional current to a lamp output;
a unidirectional stage operably connected to the bidirectional stage, the unidirectional stage having a unidirectional current;
means for monitoring the unidirectional current; and
means for generating an indicated lamp signal in response to the unidirectional current.

26. The system of claim 25 wherein the unidirectional current is selected from the group consisting of a supply current and a return current.

27. A lamp power circuit sensing system comprising:
means for monitoring bidirectional lamp voltage at a lamp output; and
means for rectifying and differentially amplifying the bidirectional lamp voltage to generate indicated lamp voltage.

28. The system of claim 27 wherein the means for rectifying and differentially amplifying the bidirectional lamp voltage comprises:
means for rectifying the bidirectional lamp voltage to generate rectified lamp voltage; and
means for differentially amplifying the rectified lamp voltage to generate the indicated lamp voltage.

29. The system of claim 27 wherein the means for rectifying and differentially amplifying the bidirectional lamp voltage comprises:
means for differentially amplifying the bidirectional lamp voltage to generate differential lamp voltage; and
means for rectifying the differential lamp voltage to generate the indicated lamp voltage.
